(19) United States
(12) Patent Application Publication
(10) Pub. No.: US 2013/0105004 A1
(43) Pub. Date: May 2, 2013

(54) HOT MELT DISPENSING SYSTEM WITH HEATED ACCUMULATOR

(71) Applicant: Graco Minnesota Inc., Minnepolis, MN (US)

(72) Inventors: Joseph E. Tix, Hastings, MN (US); Daniel P. Ross, Maplewood, MN (US); Paul Quam, Minneapolis, MN (US); Matthew Theisen, Woodbury, MN (US)

(73) Assignee: GRACO MINNESOTA INC., Minneapolis, MN (US)

(21) Appl. No.: 13/660,232

(22) Filed: Oct. 25, 2012

Related U.S. Application Data
(60) Provisional application No. 61/552,221, filed on Oct. 27, 2011.

(51) Int. Cl. F16L 53/00; F16L 55/04

(52) U.S. Cl. 137/334; 138/30

(57) ABSTRACT

An accumulator for a hot melt dispensing system includes an accumulator body; a flow passage through which hot melt adhesive flows to a dispenser; an energy storage device for storing energy based on pressure of the hot melt adhesive in the flow passage and using stored energy to apply pressure to the hot melt adhesive when pressure in the flow passage decreases; and a heating element for heating the hot melt adhesive in the accumulator.

### BACKGROUND

The present disclosure relates generally to systems for dispensing hot melt adhesive.

Hot melt dispensing systems are typically used in manufacturing assembly lines to automatically disperse an adhesive used in the construction of packaging materials such as boxes, cartons and the like. Hot melt dispensing systems conventionally comprise a material tank, heating elements, a pump and a dispenser. Solid polymer pellets are melted in the tank using a heating element before being supplied to the dispenser by the pump. Because the melted pellets will re-solidify into solid form if permitted to cool, the melted pellets must be maintained at temperature from the tank to the dispenser. This typically requires placement of heating elements in the tank, the pump and the dispenser, as well as heating any tubing or hoses that connect those components. Furthermore, conventional hot melt dispensing systems typically utilize tanks having large volumes so that extended periods of dispensing can occur after the pellets contained therein are melted. However, the large volume of pellets within the tank requires a lengthy period of time to completely melt, which increases start-up times for the system. For example, a typical tank includes a plurality of heating elements lining the walls of a rectangular, gravity-fed tank such that melted pellets along the walls prevents the heating elements from efficiently melting pellets in the center of the container. The extended time required to melt the pellets in these tanks increases the likelihood of “charring” or darkening of the adhesive due to prolonged heat exposure.

### SUMMARY

An accumulator for a hot melt dispensing system includes an accumulator body; a flow passage through which hot melt adhesive flows to a dispenser; an energy storage device for storing energy based on pressure of the hot melt adhesive in the flow passage and using stored energy to apply pressure to the hot melt adhesive when pressure in the flow passage decreases; and a heating element for heating the hot melt adhesive in the accumulator.

A method of initiating a hot melt dispensing system after a period of downtime includes initiating a melter to heat hot melt pellets into a liquid adhesive; activating a heating element in an accumulator to heat solid adhesive present within the accumulator at the same time as the melter is heating the hot melt pellets; and activating a dispensing system including a pump, a dispenser and the accumulator to uniformly dispense liquid adhesive from the system.

### BRIEF DESCRIPTION OF THE DRAWINGS

FIG. 1 is a schematic view of a system for dispensing hot melt adhesive.

FIG. 2 is a schematic view of a pump, accumulator and dispenser.

FIG. 3A is a perspective view of a heated accumulator.

FIG. 3B is an exploded view of the heated accumulator of FIG. 3A.

FIG. 3C is a cross-sectional view of the heated accumulator of FIG. 3A.

FIG. 4A is a plot of pressure of adhesive from a dispenser without an accumulator and examples of a dispensing pattern associated with the dispenser over time.

FIG. 4B is a plot of pressure of adhesive from a dispenser with an accumulator and examples of a dispensing pattern associated with the dispensing system with accumulator over time.

FIG. 5 is a cross-sectional view of an embodiment of a heated accumulator.

### DETAILED DESCRIPTION

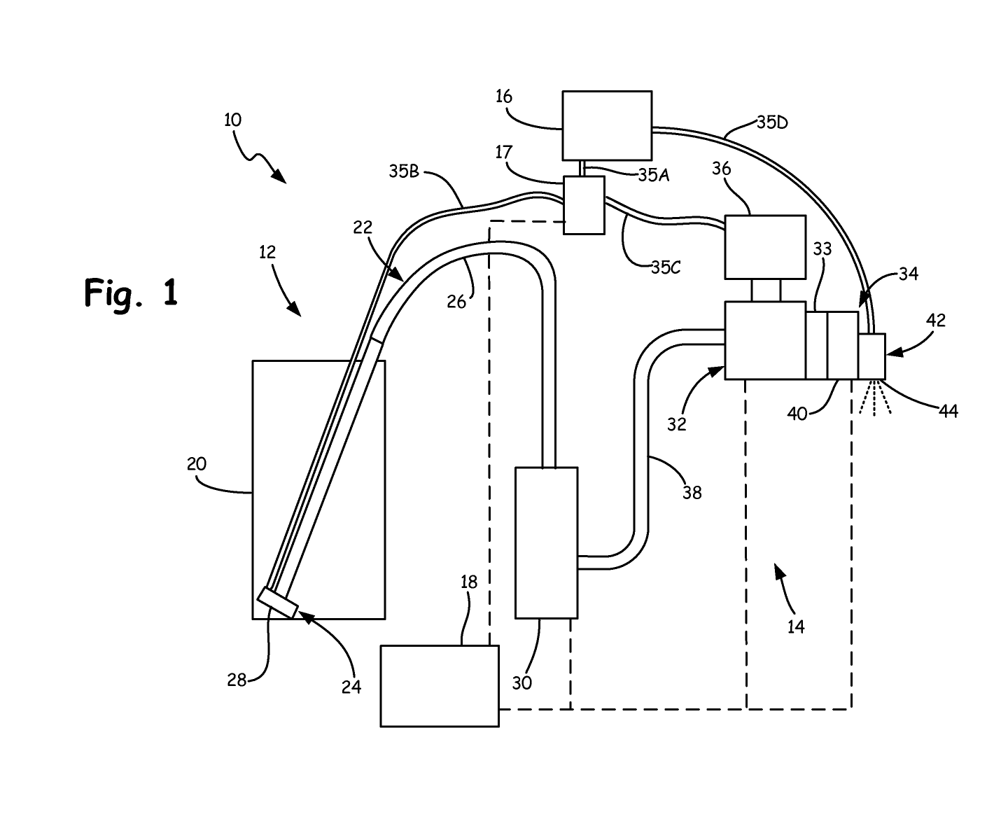

FIG. 1 is a schematic view of system 10, which is a system for dispensing hot melt adhesive. System 10 includes cold section 12, hot section 14, air source 16, air control valve 17, and controller 18. In the embodiment shown in FIG. 1, cold section 12 includes container 20 and feed assembly 22, which includes vacuum assembly 24, feed hose 26, and inlet 28. In the embodiment shown in FIG. 1, hot section 14 includes melt system 30, pump 32, accumulator 33, dispenser 34, air motor 36, supply hose 38 and accumulator 33. Air source 16 is a source of compressed air supplied to components of system 10 in both cold section 12 and hot section 14. Air control valve 17 is connected to air source 16 via air hose 35A, and selectively controls air flow from air source 16 through air hose 35B to vacuum assembly 24 and through air hose 35C to motor 36 of pump 32. Air hose 35D connects air source 16 to dispenser 34, bypassing air control valve 17. Controller 18 is connected in communication with various components of system 10, such as air control valve 17, melt system 30, pump 32, and/or dispenser 34, for controlling operation of system 10.

Components of cold section 12 can be operated at room temperature, without being heated. Container 20 can be a hopper for containing a quantity of solid adhesive pellets for use by system 10. Suitable adhesives can include, for example, a thermoplastic polymer glue such as ethylene vinyl acetate (EVA) or metallocene. Feed assembly 22 connects container 20 to hot section 14 for delivering the solid adhesive pellets from container 20 to hot section 14. Feed assembly 22 includes vacuum assembly 24 and feed hose 26. Vacuum assembly 24 is positioned in container 20. Compressed air from air source 16 and air control valve 17 is delivered to vacuum assembly 24 to create a vacuum, inducing flow of solid adhesive pellets into inlet 28 of vacuum assembly 24 and then through feed hose 26 to hot section 14. Feed hose 26 is a tube or other passage sized with a diameter substantially larger than that of the solid adhesive pellets to allow the solid adhesive pellets to flow freely through feed hose 26. Feed hose 26 connects vacuum assembly 24 to hot section 14.

Solid adhesive pellets are delivered from feed hose 26 to melt system 30. Melt system 30 can include a container (not shown) and resistive heating elements (not shown) for melting the solid adhesive pellets to form a hot melt adhesive in liquid form. Melt system 30 can be sized to have a relatively small adhesive volume, for example about 0.5 liters, and configured to melt solid adhesive pellets in a relatively short period of time. Pump 32 is driven by motor 36 to pump hot melt adhesive from melt system 30, through supply hose 38, and deliver it to dispenser 34. Motor 36 can be an air motor driven by pulses of compressed air from air source 16 and air control valve 17. Pump 32 can be a linear displacement pump driven by motor 36. In the illustrated embodiment, dispenser 34 includes manifold 40 and dispensing module 42. Heated accumulator 33 is connected to a flow passage for hot melt adhesive between pump 32 and dispenser 34. Hot melt adhesive from pump 32 and heated accumulator 33 is received in manifold 40 and dispensed via module 42. Dispenser 34 can selectively discharge hot melt adhesive whereby the hot melt adhesive is sprayed out outlet 44 of module 42 onto an object, such as a package, a case, or another object benefiting from hot melt adhesive dispensed by system 10. Module 42 can be one of multiple modules that are part of dispenser 34. In an alternative embodiment, dispenser 34 can have a different configuration, such as a handheld gun-type dispenser. Some or all of the components in hot section 14, including melt system 30, supply hose 38, pump 32, dispenser 34 and accumulator 33, can be heated to keep the hot melt adhesive in a liquid state throughout hot section 14 during the dispensing process.

System 10 can be part of an industrial process, for example, for packaging and sealing cardboard packages and/or cases of packages. In alternative embodiments, system 10 can be modified as necessary for a particular industrial process application. For example, in one embodiment (not shown), pump 32 can be separated from dispenser 34 and instead attached to melt system 30. Supply hose 38 can then connect pump 32 to dispenser 34.

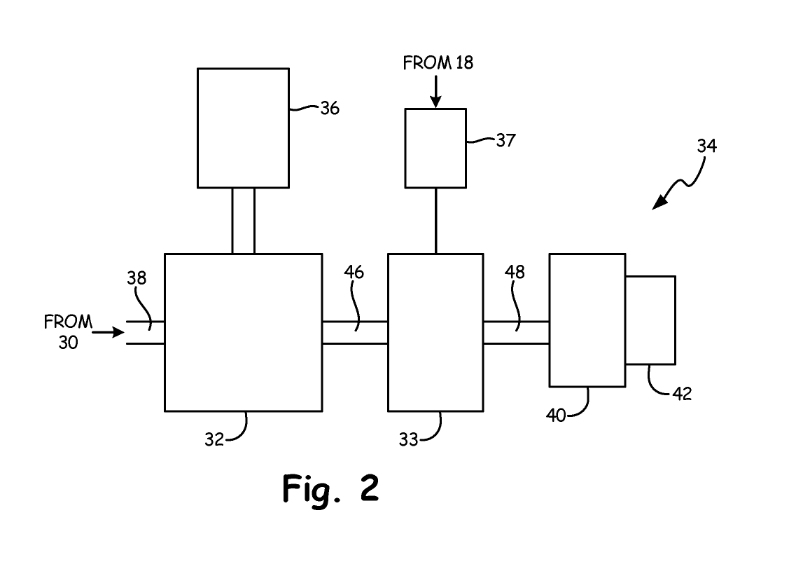

FIG. 2 is a schematic view of pump 32, heated accumulator 33, dispenser 34, motor 36 and heater control 37. Dispenser includes manifold 40 and module 42. Pump 32 is connected to heated accumulator 33 through hose 46, and heated accumulator 33 is connected to dispenser 34 through hose 48. Hoses 46 and 48 are shown for schematic purposes only, and components of the system may be connected directly to one another rather than through hoses or other components.

Pump 32 is a double-acting reciprocating piston pump which is driven by air motor 36 and operates by moving a piston in one direction to pressurize fluid on one side of the piston and then “changes over” to move the piston in the other direction to pressurize fluid on the other side. The pressurized liquid melt flows to dispenser 34. Dispenser 34 is then able to dispense liquid at the proper rate. At the “change over” point, when movement of the piston in pump 32 changes direction, the pressure drops significantly. If dispenser 34 is set to dispense at that point, the pressure of the liquid to dispenser 34 will be much less, resulting in less liquid dispensed at points when pump 32 is turning over. Heated accumulator 33 includes an energy storage medium and uses that stored energy to maintain consistent pressure levels in liquid flowing from pump 32 to dispenser 34. The energy stored in heated accumulator 33 is a function of the pressure of adhesive flowing from pump 32 to dispenser 34, and therefore when the pressure of adhesive flowing from pump 32 decreases, the stored energy is used to increase pressure of the adhesive flowing to dispenser 34. This acts to stabilize the pressure of liquid adhesive provided to dispenser 34, thereby stabilizing the output from dispenser 34 no matter the position of the piston in pump 32.

When a system for dispensing hot melt, such as the one shown in FIG. 1, is initiated after a shut-down period, the hot melt is in a solid form. Melt system 30, hose 38, pump 32, accumulator 33 and dispenser 34 include heating elements to liquefy the melt which has solidified inside of each during a shut-down period. Heater control 37 can be a power source which controls the temperature of heating elements within accumulator 33. Control signals to control heater control 37 may be provided by controller 18. Accumulator 33 includes a heating element because if it depended on conducted heat from other parts of system 10, initial start up of the hot melt dispensing system would be delayed. By using heated accumulator 33, dispenser 34 receives liquid with stable pressurization within a short period following startup of system 10.

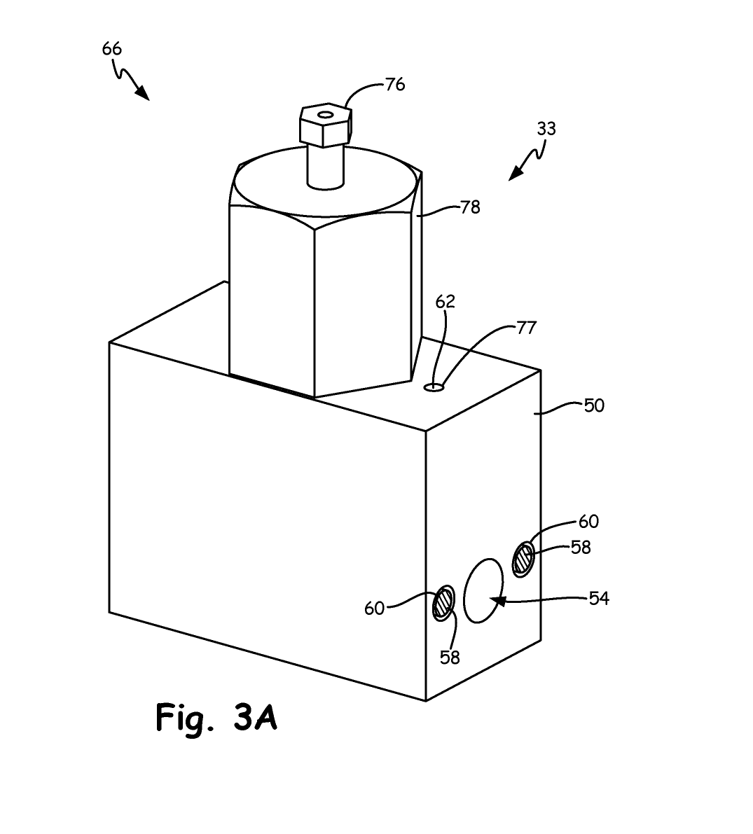

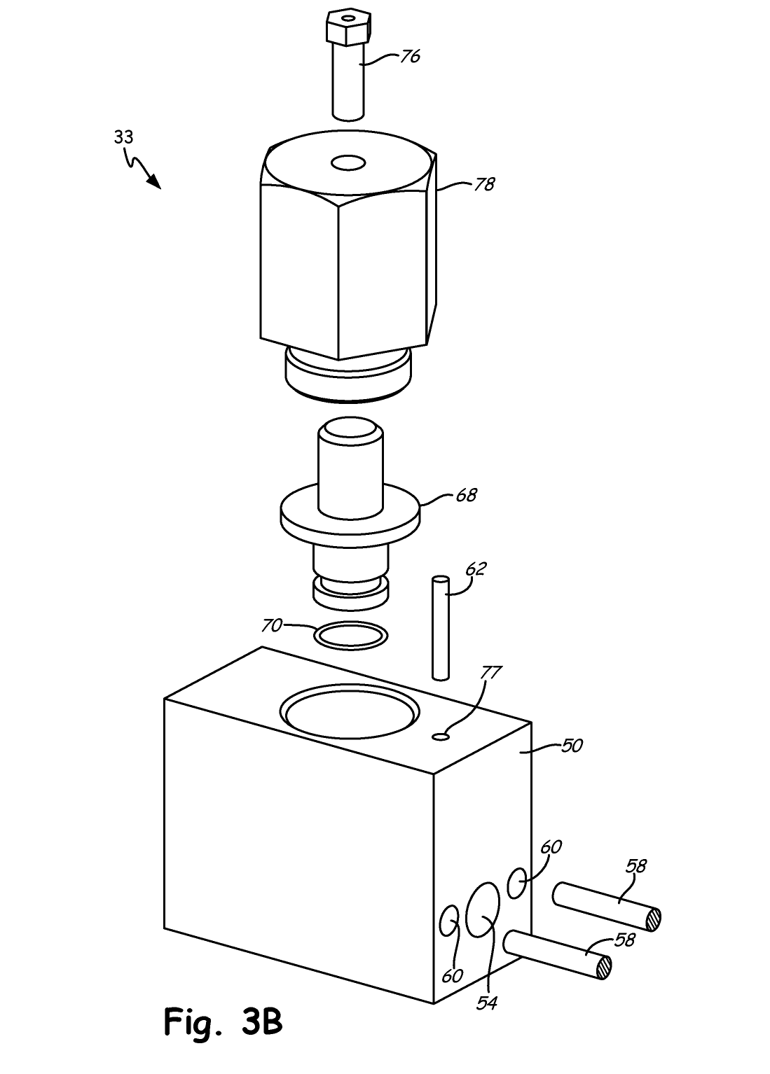

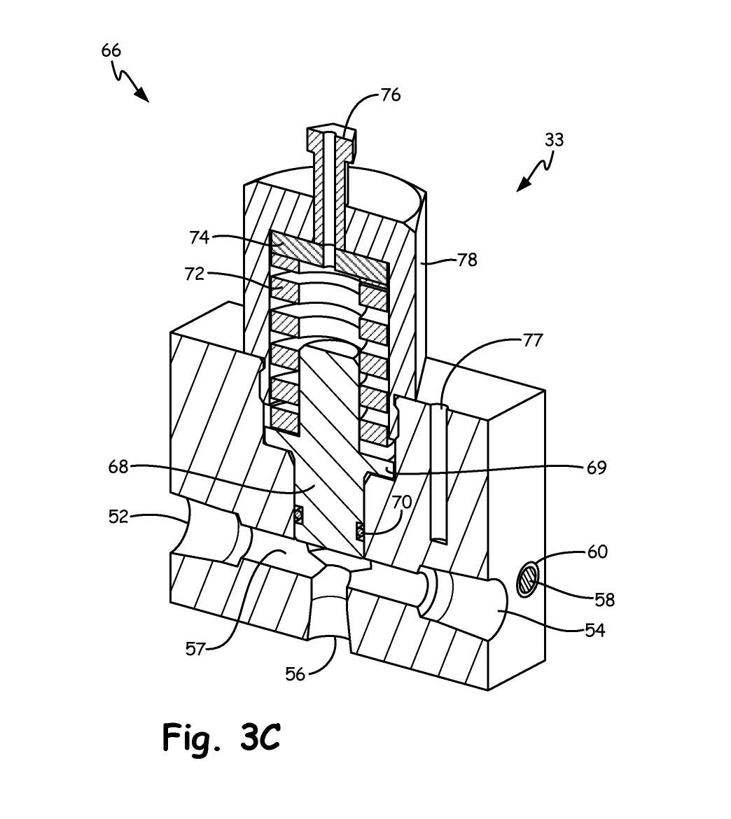

FIG. 3A is a perspective view of a first embodiment of heated accumulator 33. FIG. 3B is an exploded view of heated accumulator 33, and FIG. 3C is a cross-sectional view of heated accumulator 33. Heated accumulator 33 includes thermally conductive block 50 with inlet 52, first outlet 54, second outlet 56, hot melt flow passage 57, heater cartridges 58, heater cartridge cavities 60, temperature probe 62, piston 68 (with flange 69 and o-ring 70), spring 72, plate 74, adjustment screw 76, temperature probe port 77 and housing 78.

Heater cartridges 58 can be electrical resistance heaters connected to a power source. Heater cartridges 58 fit into heater cartridge cavities 60 in thermally conductive block 50 and are located near hot melt chamber 57. Thermally conductive block 50 can be any type of thermally conductive material, including aluminum and/or other metals. Piston 68 connects to spring 72, which connects to plate 74. Plate 74 engages screw 76, which engages housing 78 at threaded connection to housing 78. Inlet 52 could connect directly or indirectly (through a hose or fitting, for example) to an outlet at pump 32. Outlets 54, 56 connect to dispenser 34, either directly or indirectly. While two outlets 54, 56 and one inlet 52 are shown, chamber 57 could include any number of inlets and/or outlets.

Screw 76 can be adjusted by tightening or loosening it to move plate 74, therefore adjusting pre-load on spring 72, which controls movement of piston 68. Piston 68 moves up and down within housing based on opposing forces applied to piston 68 by spring 72 and pressure from hot melt adhesive within passage 57. O-ring 70 seals between piston 68 and thermally conductive block 50 to ensure liquid adhesive cannot travel along the sides of piston 68 into housing 78. Flange 69 limits movement of piston 68 within housing 78

As discussed above, accumulator 33 acts to stabilize pressure fluctuations from pump 32 to dispenser 42 (see FIGS. 1-2). When hot melt system is in operation, passage 57 is filled with liquid adhesive. Screw 76 is adjusted to pre-load spring 72 to a desired pressure for dispensing the liquid adhesive, which depends on the pressures at which pump 32 operates. When pump 32 is “turning over” and liquid pressure from pump 32 decreases, energy stored in spring 72 causes the force applied by spring 72 to piston 68 to overcome the lower adhesive pressure. Piston 68 moves toward passage 57 and increases pressure of liquid adhesive going through outlet 54 and/or outlet 56 to dispenser 42.

Hot melt systems must be shut down at various times, resulting in the liquid adhesive solidifying at room temperatures within the system. This happens in chamber 57 of accumulator 33. For accumulator 33 to function properly in stabilizing liquid adhesive, adhesive must be able to flow freely into and out of accumulator 33. Heated accumulator 33 uses heat cartridges 58 to melt adhesive in chamber 57, resulting in a system that can dispense consistent liquid adhesive shots soon after upon starting up. Temperature probe 62 sits in temperature probe port 77 and can be used to ensure that thermally conductive block 50 reaches the proper temperature for adhesive to liquefy within chamber 57. Heating cartridges 58 can stay activated for as long as it takes to liquefy in chamber 57, for example 5-10 minutes. Once hot melt adhesive within system 10 has liquefied, heating cartridges 58 may be turned off, as they are no longer needed to keep the hot melt adhesive liquefied.

The use of two outlets 54 and 56 in accumulator 33 provides more fluid movement through accumulator chamber 57 as well. When liquid adhesive stays heated in one place, it can start to experience undesirable charring. The number and placement of inlets and/or outlets to passage 57 can encourage liquid movement through passage 57, for example, by placing outlet 54 directly downstream from inlet 52 and placing outlet 56 directly downstream from where piston 68 will be imparting pressure to hot melt in passage 57. This helps hot melt to move through passage 57, avoiding dwelling and thus charring. Outlets 54 and 56 can be connected to form one stream to dispenser 34 or could go to multiple dispensers 34.

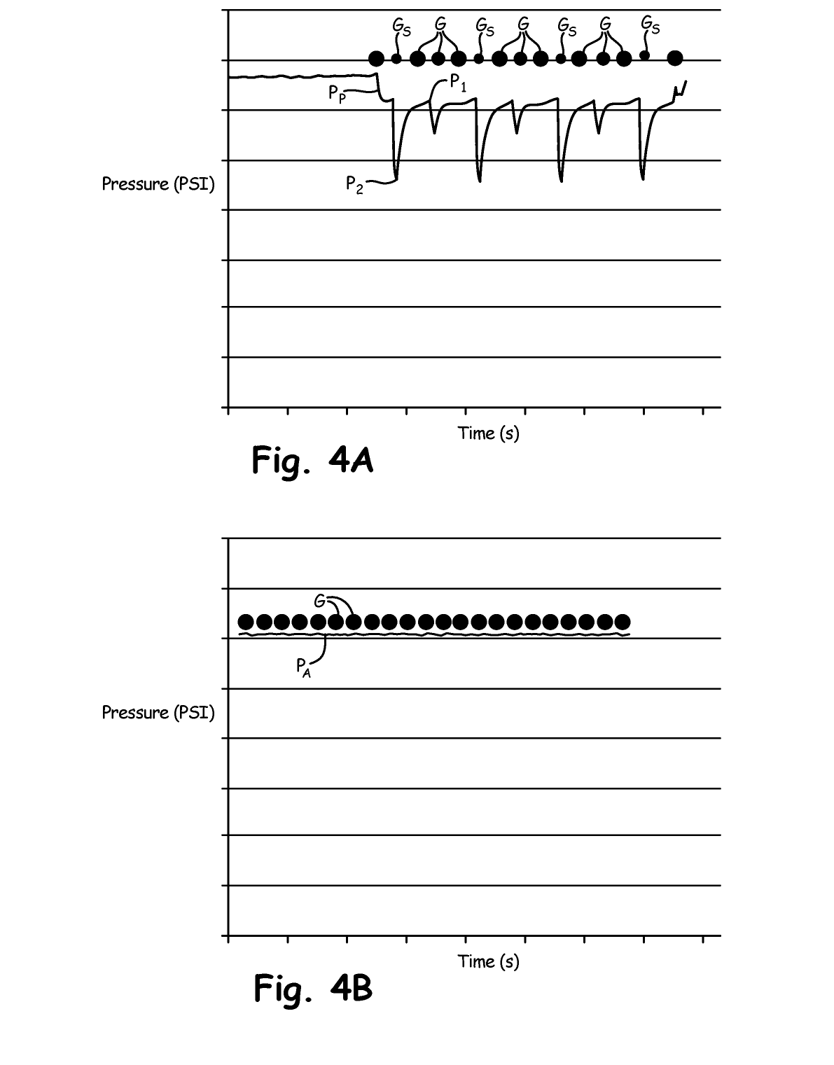

FIG. 4A is a plot of pressure of adhesive from a dispenser without an accumulator and examples of a dispensing pattern associated with the dispenser over time. FIG. 4A includes line P_{P} showing pressure of liquid adhesive going to dispenser 34 from pump 32 in a system which does not include accumulator 33. Also included are example glue shot sizes G.

As can be seen, pressure P_{P} ranges from P₁ psi to P₂ psi. It fluctuates based on the piston position of reciprocating piston pump 32. Shots from dispenser 34 are not coordinated with pump 32, so shots occur randomly with respect to pump 32 piston position. When pump 32 “changes over” (i.e., reverses piston direction) pressure drops to P₂ psi. At that time, if liquid adhesive is being dispensed, the shot is Gₛ smaller than a normal size shot G. Fluctuations vary due to pump 34 having the different change over points when configured as a double-acting piston pump.

FIG. 4B is a plot of pressure of adhesive from dispenser 42 in a system with accumulator 33 and examples of a dispensing pattern associated with the dispensing system 10 with accumulator 33 over time. FIG. 4B includes line P_{A} showing pressure of liquid adhesive going to dispenser 42 from pump 32 and/or accumulator 33 and example glue shot sizes out of dispenser 41.

The use of accumulator 33 levels out pressure fluctuations in liquid adhesive delivered to dispenser 42. This flow of liquid with stabilized pressure results in glue shots G which are consistently the same size, not varying with pump cycling.

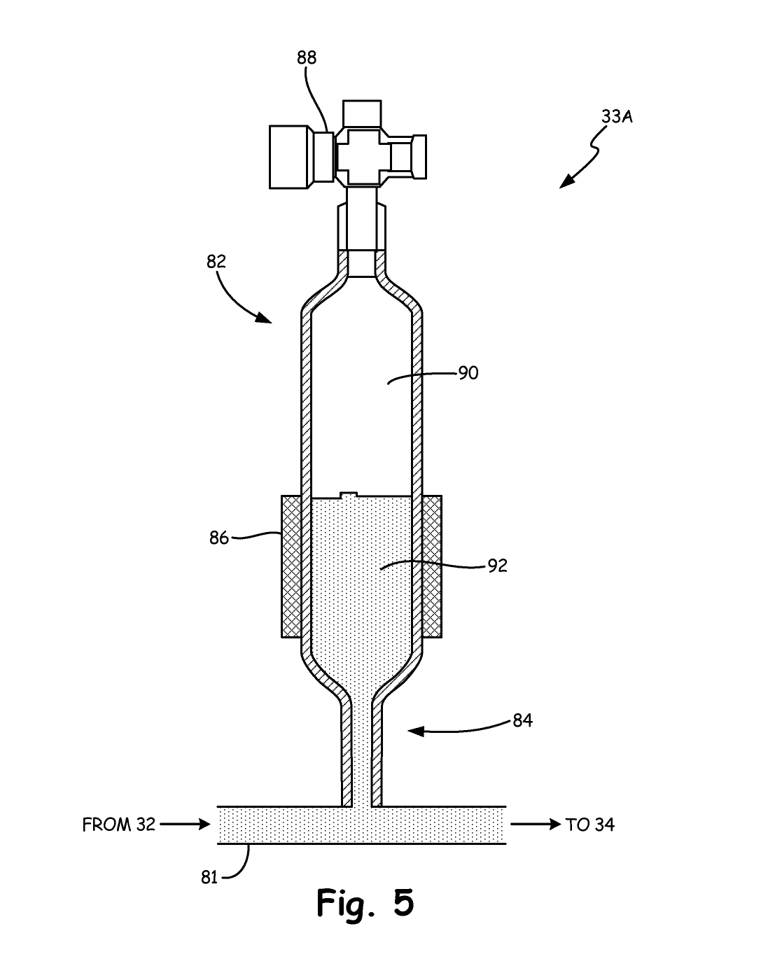

FIG. 5 is a cross-sectional view of a second embodiment of a heated accumulator 33A, and includes flow passage 81 (going from pump 32 to dispenser 34), accumulator bottle or vessel 82 (containing compressed gas 90 and liquid adhesive 92) with port 84, heating element 86 and valve 88. Heating element 86 can be a band heater which wraps around bottle 82 and includes wires which receive power from a power source (not shown) and heat up due to resistive heating. Valve 88 receives air from compressed air source to control pressure of gas 90 within accumulator 33A.

Port 84 is connected to flow passage 81 through which liquid adhesive travels from pump 32 to dispenser 42. In the embodiment shown in FIG. 5, the energy storage medium for accumulator is compressed gas 90 within accumulator chamber or vessel 82. Gas 90 is pressurized using valve 88 based on the desired pressure level of liquid adhesive going to dispenser 42. The pressure of gas 90 applies a force on liquid adhesive 92 that opposes the force applied by the pressure of liquid adhesive 92 in passage 81 When pump 32 changes over (lowering pressure of adhesive through line 81), pressurized gas 90 in accumulator bottle 82 applies force to liquid adhesive 92 out of bottle to increase pressure in line 81 flowing to dispenser 34. This ensures liquid adhesive in line 81 flowing to dispenser 34 remains at stable pressure, therefore ensuring more uniform dispensed shot sizes.

By including heating element 86 with accumulator 33A, system 10 can begin dispensing liquid adhesive with consistent shot sizes beginning at start up. Accumulator 33A with heating elements 86 eliminates the need to either wait for accumulator to gradually warm up to liquefy adhesive within accumulator bottle 82 or to run system 10 without accumulator and endure varying pressures and thus shot sizes until adhesive within an accumulator is heated through convection from other heated parts of system 10.

Accumulators 33, 33A with heating elements 58, 86 additionally can remove the need for long hoses of past systems, allowing dispenser to be placed right next to pump 32, thereby reducing overall footprint of system 10. Reduction in hose length also reduces the amount of adhesive that needs to be reheated when restarting system 10. Past systems sometimes used long hoses to help level out the pressure fluctuations caused by pump 32 change over. These long hoses required heating wires, which reduced hose flexibility and often resulted in kinks that caused a burn out of the wires and failure points in hoses. Heated accumulator 33, 33A allow dispenser 34 to be placed at or near pump 32, though they can still be used with hoses. When used with hoses, they can minimize the length of hose required (as length is no longer needed to reduce pressure fluctuations), and thus minimize failure points.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the appended claims.

1. An accumulator for a hot melt dispensing system, the accumulator comprising:
an accumulator body;
a flow passage through which hot melt adhesive flows to a dispenser;
an energy storage device for storing energy based on pressure of the hot melt adhesive in the flow passage and using stored energy to apply pressure to the hot melt adhesive when pressure in the flow passage decreases; and
a heating element for heating the hot melt adhesive in the accumulator.

2. The accumulator of claim 1, wherein the heating element is a heater cartridge located near the chamber.

3. The accumulator of claim 1, and further comprising:
one or more additional heating elements.

4. The accumulator of claim 1, wherein the heating element is a band heater.

5. The accumulator of claim 1, wherein the energy storage device comprises:
a chamber in the accumulator body that is in communication with the flow passage;
a piston movable within the chamber to adjust pressure of hot melt adhesive within the chamber; and
a spring connected to the piston to store energy and to apply force on the piston.

6. The accumulator of claim 5, wherein the energy storage device further comprises:
a plate connected to the spring to control a pre-load on the spring; and
an adjustable screw connected to the plate to adjust the plate and the pre-load on the spring.

7. The accumulator of claim 1, wherein the flow passage comprises:
at least one inlet port; and
at least one outlet port.

8. The accumulator of claim 1, wherein the energy storage device comprises:
a chamber within the accumulator body that is in communication with the flow passage; and
compressed gas within the chamber to store energy and to apply force on liquid adhesive in the chamber.

9. The accumulator of claim 1, and further comprising:
a flow passage inlet to receive liquid adhesive from the line; and
a flow passage outlet connected to a dispensing system to deliver liquid adhesive from the accumulator to the dispensing system.

10. The accumulator of claim 1, and further comprising:
a temperature probe.

11. A hot melt dispensing system comprising:
a melter capable of heating hot melt pellets into a liquid adhesive;
a dispensing system with a dispenser for delivering liquid adhesive from the melter; and
an accumulator, connected to a flow passage through which liquid adhesive is delivered to the dispensing system, for stabilizing pressure of liquid adhesive delivered to the dispensing system; and
a heater for heating the accumulator when adhesive within the accumulator is in a solid state.

12. The hot melt dispensing system of claim 11, and further comprising:
a reciprocating piston pump to pressurize the liquid adhesive.

13. The hot melt dispensing system of claim 12, wherein the accumulator is connected to the flow passage between the pump and the dispenser.

14. The hot melt dispensing system of claim 13, wherein the dispenser dispenses the adhesive in shots and the accumulator stabilizes pressure between the pump and the dispenser to ensure each shot dispensed is of uniform size.

15. The hot melt dispensing system of claim 13, wherein the heated accumulator further comprises:
an energy storage device for applying pressure to the hot melt adhesive in the accumulator when the pressure from the pump decreases.

16. The hot melt dispensing system of claim 15, wherein the energy storage device comprises:
a chamber in the accumulator body that is in communication with the flow passage;
a piston movable within the chamber to adjust pressure of hot melt adhesive within the chamber; and
a spring connected to the piston to store energy and to apply force on the piston.

17. The hot melt dispensing system of claim 16, wherein the energy storage device further comprises
a plate connected to the spring to control a pre-load on the spring; and
an adjustable screw connected to the plate to adjust the plate and the pre-load on the spring.

18. The hot melt dispensing system of claim 15, wherein the energy storage device comprises:
a chamber within the accumulator body that is in communication with the flow passage; and
compressed gas within the chamber to store energy and to apply force on liquid adhesive in the chamber.

19. A method of initiating a hot melt dispensing system after a period of downtime, the method comprising:
initiating a melter to heat hot melt pellets into a liquid adhesive;
activating a heating element in an accumulator to heat solid adhesive present within the accumulator at the same time as the melter is heating the hot melt pellets; and
activating a dispensing system including a pump, a dispenser and the accumulator to uniformly dispense liquid adhesive from the system.

20. The method of claim 19, wherein activating a dispensing system comprises:
starting a reciprocating piston pump to pressurize the liquid adhesive from the melter;
applying pressure with the accumulator to provide stabilizing pressure to the liquid adhesive flowing from the pump; and
dispensing liquid adhesive shots from a dispenser.
